(19) United States
(12) Patent Application Publication
(10) Pub. No.: US 2013/0072291 A1
(43) Pub. Date: Mar. 21, 2013

(54) GAME MACHINE AND GAME SYSTEM

(71) Applicants: Ryu SASAKI, Minato-ku (JP); Masato OKUAKI, Minato-ku (JP); Hiroto NAKAMOTO, Minato-ku (JP); Atsushi INOUE, Las Vegas, NV (US)

(72) Inventors: Ryu SASAKI, Minato-ku (JP); Masato OKUAKI, Minato-ku (JP); Hiroto NAKAMOTO, Minato-ku (JP); Atsushi INOUE, Las Vegas, NV (US)

(73) Assignee: KONAMI DIGITAL ENTERTAINMENT CO., LTD., Tokyo (JP)

(21) Appl. No.: 13/608,428

(22) Filed: Sep. 10, 2012

(30) Foreign Application Priority Data
Sep. 20, 2011 (JP) 2011-205184

(51) Int. Cl. A63F 13/06

(52) U.S. Cl. 463/25; 463/37

(57) ABSTRACT

In a game machine which is provided with an input interface having a configuration in which a game field on which a game progresses according to movement of medals, a monitor, and a touch panel superimposed on the monitor are combined, and a control unit, the control unit causes a digital medal associated with the medal to be displayed on the monitor, causes the digital medal to be associated with the player's touch operation, causes the digital medal to operate according to a predetermined operation condition, applies an operation associated with an operation of the digital medal to the medal, and selects the operation condition according to a predetermined selection condition from among a plurality of candidates of the operation condition.

### CROSS-REFERENCE TO RELATED APPLICATIONS

The present application claims the benefit of patent application number 2011-205184, filed in Japan on Sep. 20, 2011, the subject matter of which is hereby incorporated herein by reference.

### TECHNICAL FIELD

The present invention relates to a game machine and the like in which a medal is inserted into a game field, and a game is played as the metal moves.

### BACKGROUND ART

Game machines using physical movement of a metal are well known. For example, pusher games in which a group of medals are pushed out by a pusher table that reciprocates along a game field, and the medals discharged to the outside of the game field are dispensed to a player have been known (for example, see Patent Literature 1).

Patent Literature 1: JP-A-2005-224322.

### SUMMARY OF INVENTION

### Technical Problem

In a pusher game, a game is played as the player inserts medals into the game field one by one. An action of inserting medals is cumbersome to players who desire to continuously insert medals. Further, as the player continuously inserts medals, the player's hand may get dirty. For these reasons, the player may become disaffected with the handling of a game medium such as a medal.

Thus, the present invention aims to provide a game machine and a game system, which are capable of improving operability related to the handling of a game medium.

### Solution to Problem

The game machine of the present invention is a game machine comprising: an input interface having a configuration in which a game field on which a game progresses according to movement of a physical game medium, a display device, and a touch panel superimposed on the display device are combined; a control device which causes a virtual game medium associated with the physical game medium to be displayed on the display device, causes the virtual game medium to be associated with the player's touch operation, causes the virtual game medium to operate according to a predetermined operation condition, and applies an operation associated with an operation of the virtual game medium to a physical game medium; and a operation condition selecting device which selects an operation condition in the control device according to a predetermined selection condition from among a plurality of candidates of the operation condition.

According to the game machine of the present invention, a physical game medium associated with the virtual game medium moves on the game field according to a touch operation on the virtual game medium displayed on the display device of the input interface. Since the operation condition of the virtual game medium is selected from a plurality of candidates according to the selection condition, an operation of the virtual game medium is diversified. Since the physical game medium can move on the game field by operating the virtual game medium through the input interface, the player can enjoy a game without coming into contact with the physical game medium. Since an operation of the virtual game medium can be set according to the player's tendency or preference, operability related to the handling of a game medium can be improved.

As one aspect of the game machine of the present invention, further comprising an inserting mechanism which inserts the physical game medium into the game field, wherein the control device includes an inserting mechanism control device which controls the inserting mechanism based on the touch operation made through the input interface. According to this, the player can inserts the physical game medium into the game field by performing the touch operation on the virtual game medium.

As one aspect of the game machine of the present invention, the control device includes a virtual game medium synthesizing device which synthesizes a plurality of virtual game media into one synthesized virtual game medium on which a touch operation can be performed. According to this, the plurality of virtual game media can be operated through the input interface as one synthesized virtual game medium. Since the plurality of synthesized virtual game media can be operated by operating one synthesized virtual game medium, operability is improved.

As the aspect of comprising the virtual game medium synthesizing device, when a touch operation of inserting the physical game medium into the game field is performed on the synthesized virtual game medium, the inserting mechanism control device inserts physical game media which correspond in number to the number of virtual game media used for the synthesis of the synthesized virtual game medium into the game field. According to this, when the insertion operation is performed on the synthesized virtual game medium, the physical game media which correspond in number to the number of media used for the synthesis are inserted into the game field. The physical game media can be continuously inserted into by a simple operation.

As one aspect of the game machine of the present invention, the control device causes a predetermined number or less of virtual game media to be displayed on the display device, and when the number of virtual game media exceeds the predetermined number, the control device causes the exceeding number to be displayed. According to this, the number of virtual game media which are not displayed on the display device is displayed, and so the player can understand the number of possessed virtual game media. Even when the player possesses many virtual game media, a game can be played without damaging operability.

As the aspect of comprising the inserting mechanism control device, further comprising: a physical game medium insertion slot through which the physical game medium is inserted; and a physical game medium detecting device which detects a physical game medium inserted into the physical game medium insertion slot, wherein the inserting mechanism control device controls the inserting mechanism based on the detection result of the physical game medium detecting device. According to this, the touch operation can be performed on the virtual game medium, and the insertion operation of inserting the physical game medium into the game field can be performed. A game can be played by either operation according to the player's preference, and so operability is improved.

As one aspect of the game machine of the present invention, further comprising: a physical game medium dispensing device which dispenses the physical game medium to the player; a virtual game medium dispensing device which dispenses the virtual game medium to the player; and a dispensing setting device which sets either of the physical game medium dispensing device and the virtual game medium dispensing device as a dispensing device based on the player's selection. According to this, when the game medium is dispensed to the player, either of the physical game medium and the virtual game medium can be selected as a dispensing target. The game medium to be dispensed can be changed according to the player's preference, and so operability is improved.

As one aspect of the game machine of the present invention, a player's selection of the selection condition from a plurality of candidates of the operation condition is set, and the operation condition selecting device selects the operation condition based on the player's selection operation. According to this, an operation of the virtual game medium is decided according to the player's selection. Since an operation of the virtual game medium is selected according to the player's preference, various operation feelings can be obtained, and so operability is improved.

As one aspect of the game machine of the present invention, a predetermined item of a play history of a game play of a player is set as the selection condition, and the operation condition selecting device selects the operation condition based on the play history. According to this, an operation of the virtual game medium changes according to the player's game play tendency. For example, an operation in which a virtual game medium appears when a specific condition is satisfied may be set, and so a game's property can be diversified.

As one aspect of the game machine of the present invention, a touch operation to insert a physical game medium associated with a virtual game medium displayed on the display device into the game field is set as the operation condition. According to this, a method of operating the virtual game medium can be diversified. As one aspect of the game machine of the present invention, the speed at which the virtual game medium displayed on the display device moves is set as the operation condition. Further, as one aspect of the game machine of the present invention, the size of the virtual game medium displayed on the display device is set as the operation condition.

As one aspect of the game machine of the present invention, comprising an electronic fee collecting device which can collect a fee used to purchase a virtual game medium through an exchange of electronic payment information. According to this, since the virtual game medium can be purchased in the game machine, it is possible to enjoy a game without stopping the game even though there is a shortage of a game medium. Further, as one aspect of the game machine of the present invention, comprising: the above-described game machine; and a server which can perform communication with the game machine via a network; wherein the server includes an electronic fee collecting device which can collect a fee used to purchase a virtual game medium through an exchange of electronic payment information.

### Advantageous Effects of Invention

As described above, according to the invention, a physical game medium associated with a virtual game medium displayed on a display device of an input interface moves on a game field according to a touch operation on the virtual game medium. Since the operation condition of the virtual game medium is selected from a plurality of candidates according to the selection condition, an operation of the virtual game medium is diversified. Since it is possible to operate the physical game medium on the game field by operating the virtual game medium on the input interface, the player can enjoy a game without coming into contact with the physical game medium. Since an operation of a virtual game medium can be set according to the player's tendency or preference, operability related to the handling of a game medium can be improved.

### BRIEF DESCRIPTION OF DRAWINGS

FIG. 1 is an overall view of a game machine according to one aspect of the present invention.

FIG. 2 is a perspective view of a station unit.

FIG. 3 is an enlarged view of a monitor.

FIG. 4 is a functional block diagram illustrating a configuration of a control system of a game machine.

FIG. 5 is a flowchart illustrating a digital medal insertion process routine executed by a station control unit.

FIG. 6 is a flowchart illustrating a medal synthesizing process routine executed by a station control unit.

FIG. 7 is a flowchart illustrating an operating unit changing process routine executed by a station control unit.

FIG. 8 is a view illustrating an example of the layout of an operating unit.

FIG. 9 is a view illustrating another example of the layout of an operating unit.

FIG. 10 is a view illustrating another example of the layout of an operating unit.

FIG. 11 is a view illustrating another example of the layout of an operating unit.

FIG. 12 is a functional block diagram illustrating a modified embodiment of a server.

### DESCRIPTION OF EMBODIMENTS

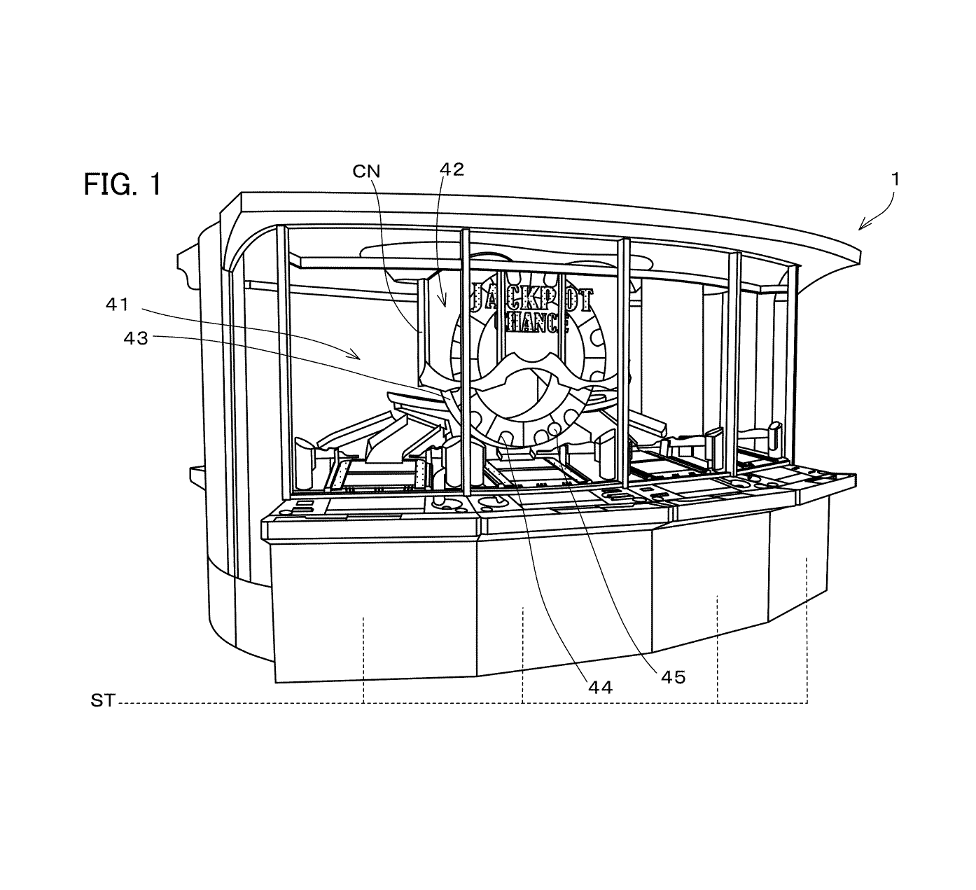

FIG. 1 is an overall view of a game machine that configures a game system according to one aspect of the present invention. A game machine 1 is a so-called medal game machine that uses a medal M as a game medium. The game machine 1 includes a center unit CN and a plurality of station units ST. The center unit CN is arranged at the center of the game machine 1, and executes a bonus game corresponding to a game result of the station unit ST. The station unit ST is arranged around the center unit CN. For example, eight station units ST are arranged such that four station units ST and four station units ST are arranged at both sides, respectively with the center unit CN interposed therebetween. The station unit ST executes a so-called pusher game using a medal and a digital lottery game corresponding to a game result of the pusher game.

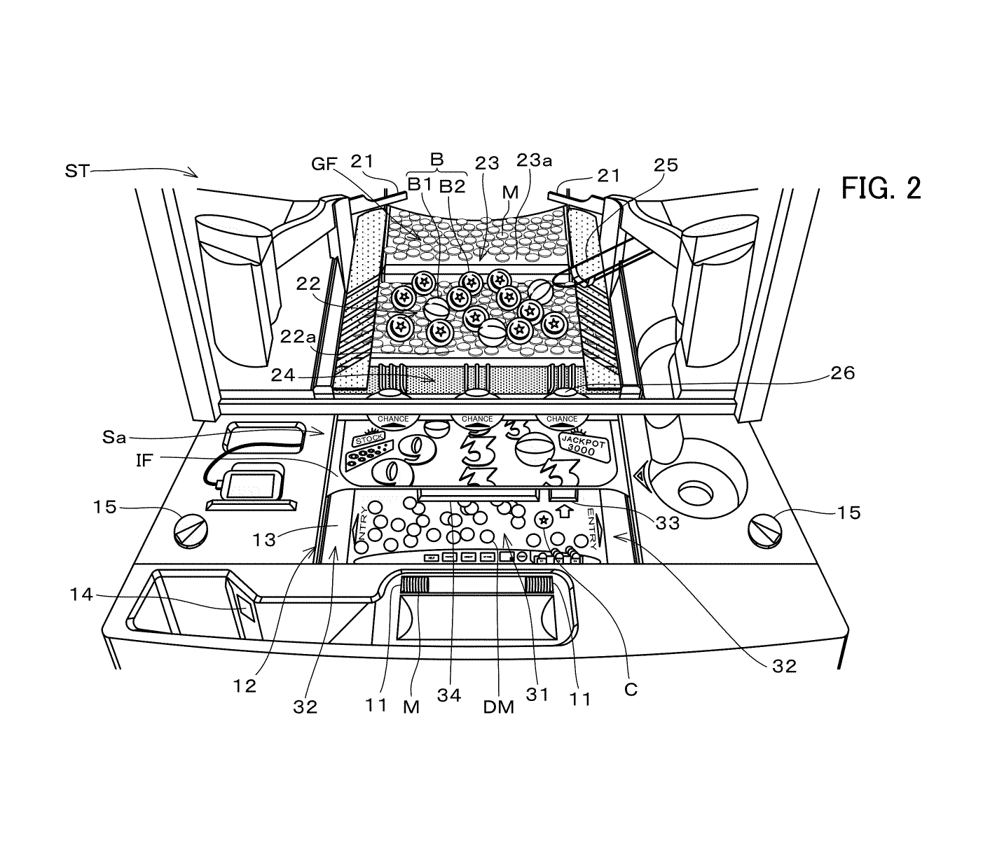

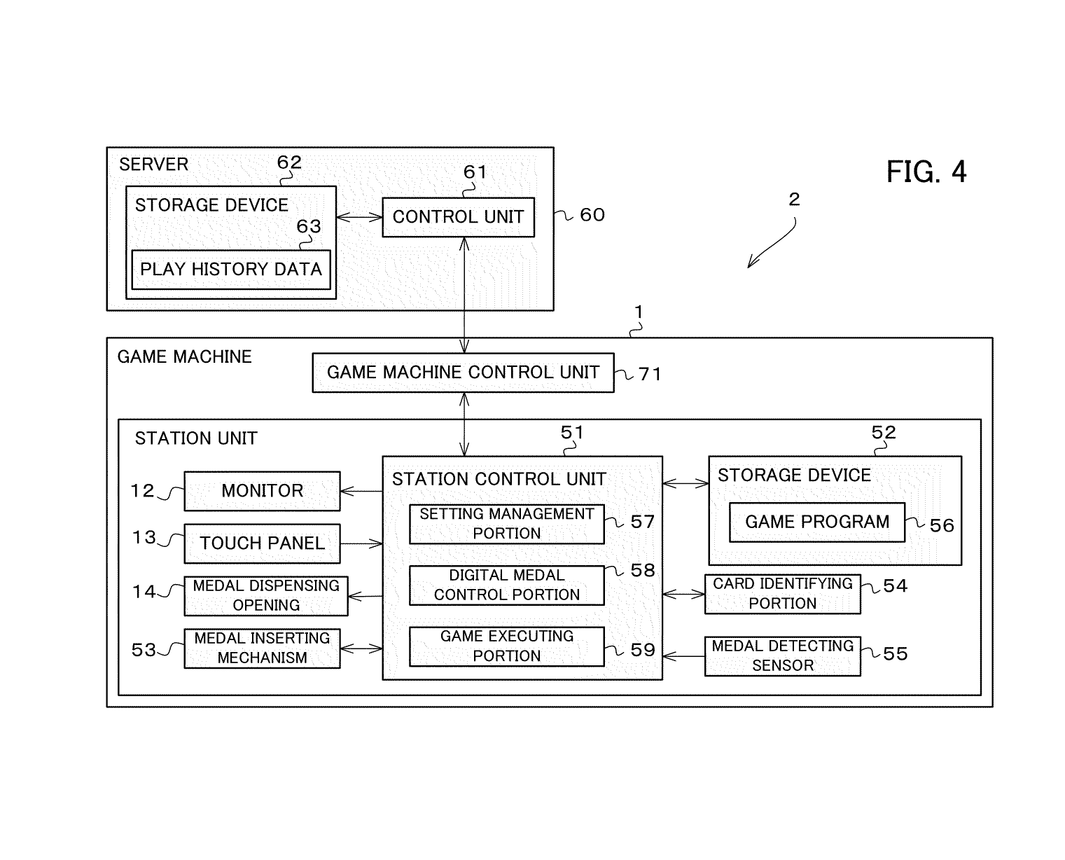

FIG. 2 is a perspective view of the station unit ST. The station unit ST includes a game field GF which is configured with a table 22 and a pusher table 23. A pusher game using the game field GF is executed in the station unit ST. The station unit ST is provided with a medal insertion slot 11 through which the medal M used as a physical game medium is inserted into the game field GF, a monitor 12 functioning as a display device, a transparent touch panel 13 superimposed on the surface of the monitor 12, a medal dispensing opening 14 functioning as a physical game medium dispensing device that dispenses the medal M according to a result of a game executed by each station unit ST or the center unit CN, a rail operating portion 15. Two medal insertion slots 11 are disposed in each station unit ST, and two players can simultaneously play through a single station unit ST. A medal detecting sensor 55 (FIG. 4) functioning as a physical game medium detecting device that detects the medal M is disposed on a path of the medal M inserted from the medal insertion slot 11. When the medal detecting sensor 55 detects the medal M, the medal M is supplied to the game field GF along a medal supply rail 21 which will be described later.

A game screen Sa is displayed on the monitor 12. In FIG. 2, a slot game is displayed on an upper portion of the monitor 12, and an operating unit 31 that operates a digital medal DM functioning as a virtual game medium and a chip C is displayed on a lower portion of the monitor 12. A slot game is a digital lottery game which a control unit 61, which will be described later, executes according to a game result of the game field GF. The operating unit 31 is provided with a digital medal insertion slot 32 into which the digital medal DM is inserted, a chip insertion slot 33 into which the chip C is inserted, and a digital medal dispensing opening 34. As the digital medal DM is guided to the digital medal insertion slot 32 by a touch operation, the actual medal M is inserted into the game field GF through the medal supply rail 21 which will be described later. One digital medal DM is equivalent to one actual medal M, however, for example, one digital medal DM may be set to be equivalent to three medals M.

Besides, a digital lottery game different from that in FIG. 2, a rendering effect at the time of winning, or the like is appropriately displayed on the monitor 12 depending on a game result of each station unit ST or the center unit CN. Through the touch panel 13, a touch operation associated with an image such as the digital medal DM displayed on the monitor 12 or an operation button of the digital lottery game can be made. The actual medal M is dispensed through the medal dispensing opening 14. The station unit ST may dispense the digital medal DM instead of dispensing the actual medal through the medal dispensing opening 14. In this case, an image of the digital medal DM dispensed through the digital medal dispensing opening 34 or the number of acquired medals is displayed. The monitor 12 and the touch panel 13 function as an input interface IF. A maximum of a predetermined number of digital medals DM are displayed on the operating unit 31. The number of digital medals DM is managed in credit, and the number of digital medals DM possessed by the player excluding a maximum of a predetermined number of digital medals DM displayed on the operating unit 31 is displayed. A method of displaying the digital medal DM may be appropriately changed. The predetermined number may be changed according to the size of the digital medal DM displayed on the monitor 12. For example, by reducing the size of the digital medal DM, more digital medals DM may be displayed on the operating unit 31.

The station unit ST is provided with the medal supply rail 21 along which the medal M is supplied to the game field GF, the table 22 on which the medal M and a ball B are placed, the pusher table 23 that reciprocates over the table 22, a falling portion 24 that is positioned on a front end of the table 22 onto which the medal M and the ball B fall, a ball supply rail 25 along which the ball B is supplied to the table 22, and a checker 26 that detects the medal M. The medal supply rail 21 causes the medal M to be supplied to the pusher table 23 when the medal M is inserted into the medal insertion slot 11 or when an insertion operation of the digital medal DM is made by the touch panel 13. The medal M is supplied to the medal supply rail 21 through the medal inserting mechanism 53 (FIG. 4). The medal inserting mechanism 53 is provided with a medal storage portion that stores the medal M and an introducing portion that repeatedly introduces the medal M from the medal storage portion to the medal supply rail 21 one by one. The medal inserting mechanism 53 introduces the medal M stored in the medal storage portion from the introducing portion to the medal supply rail 21 based on a detection result of the medal detecting sensor 55 or the player's insertion operation of the digital medal DM by the operating unit 31. The medal inserting mechanism 53 may be configured using various known techniques.

As the rail operating portion 15 is operated, an insertion direction of the medal M of the medal supply rail 21 changes. The pusher table 23 reciprocates in a front-back direction by a driving mechanism (not illustrated). The medal M and the ball B pushed out by the pusher table 23 fall onto the falling portion 24. When the ball B falls onto the falling portion 24, a ball detecting portion (not illustrated) detects the ball B. When seven balls B are detected by the ball detecting portion, a first roulette game is executed as the digital lottery game. Even though not illustrated in the drawings, the first roulette game is displayed on the monitor 12. The ball supply rail 25 supplies the ball B to the table 22 according to the game result of each station unit ST or the center unit CN. The checker 26 is disposed at the position adjacent to the falling portion 24. The slot game displayed on the monitor 12 illustrated in FIG. 2 is executed as another digital lottery game based on detection of the medal M by the checker 26. The ball detecting unit, the medal detecting sensor 55, and the checker 26 may be configured using a well-known technique such as a photoelectric sensor.

Next, the move of the medal M in the game field GF will be briefly described. When the player inserts the medal M into the medal insertion slot 11, the medal M is introduced from the medal inserting mechanism 53 to the medal supply rail 21 based on the detection result of the medal detecting sensor 55. Alternatively, when the player operates the operating unit 31 to insert the digital medal DM into the digital medal insertion slot 32, the medal M is introduced from the medal inserting mechanism 53 to the medal supply rail 21. The medal M is supplied to a medal placing surface 23a of the pusher table 23 through the medal supply rail 21. A group of medals on the medal placing surface 23a is pushed out by reciprocation of the pusher table 23, so that some medals of a group of medals are moved onto a medal placing surface 22a of the table 22. The balls B are placed on a group of medals on the medal placing surface 22a. A group of medals is pushed out by reciprocation of the pusher table 23, and so the balls B move with the movement of a group of medals. The medal M fallen onto the falling portion 24 is dispensed from the medal dispensing opening 14. Alternatively, the digital medal DM is dispensed from the digital medal dispensing opening 34. Further, when the medal M enters the checker 26, a game process of the slot game illustrated in FIG. 2 is executed based on the detection result of the medal M by the checker 26. When payout is paid to the player who won the slot game, the medals M which correspond in number to the payout are supplied from a medal supply opening (not illustrated) to the game field GF. An orb ball B1 and a chip ball B2 are provided as the ball B placed on the table 22. Here, when seven orb balls B1 fall onto the falling portion 24, the first roulette game is executed as the digital lottery game. The chip ball B2 is collectable as the chip C. A process corresponding to the type of the fallen ball B is executed.

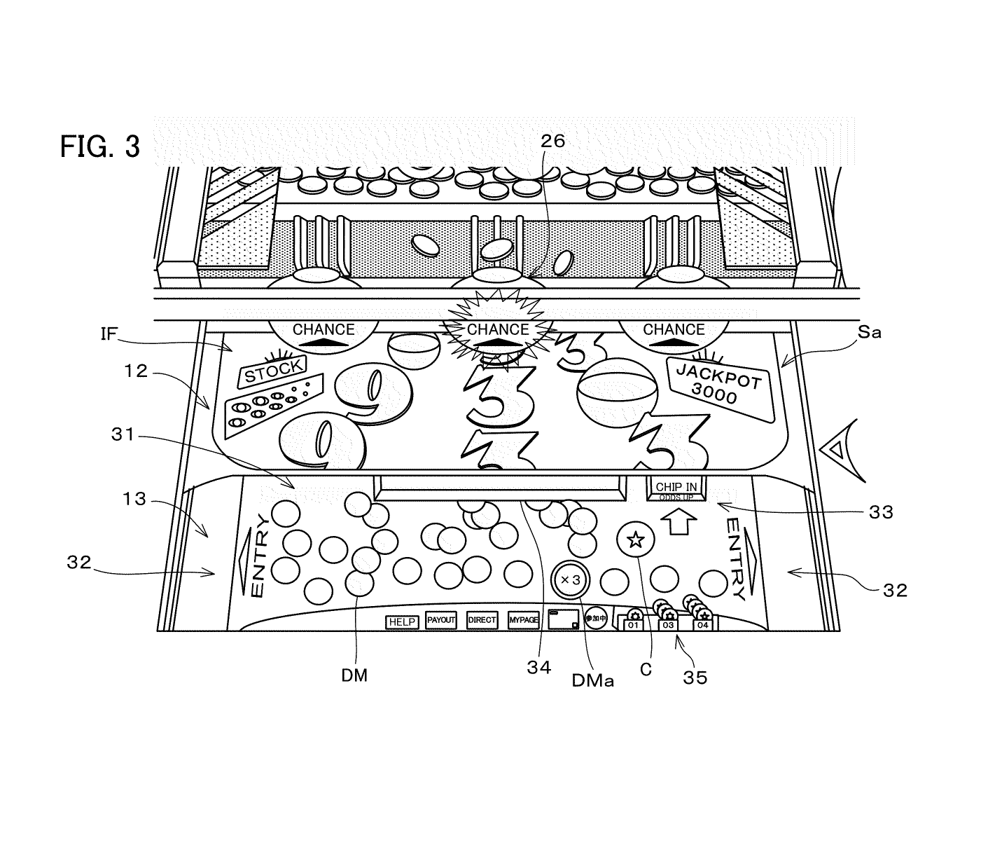

The chip ball B2 fallen onto the falling portion 24 is detected by the ball detecting portion (not illustrated). The player acquires the chip C based on the detection result of the chip ball B2 by the ball detecting portion. The player acquires one chip C when one chip ball B2 falls. Two or more types of chip balls B2 may be provided, and the type of acquirable chip C or the number of acquirable chips C may differ according to the type of chip ball B2. Alternatively, the chip C may be acquired depending on the game result of each station unit ST or the center unit CN. FIG. 3 is an enlarged view of the monitor 12. When the player inserts the chip C displayed on the monitor 12 into the chip insertion slot 33 by a touch operation, payout of the digital lottery game executed based on the detection result of the checker 26 becomes higher payout during a predetermined time period. In FIG. 3, the slot game is executed as the digital lottery game. For example, if thirty medals are paid out at a normal time, 100 medals are paid out when the chip C is used. When the chip C is used, a rendering effect of the slot game may change. Further, when the chip C is used, a winning probability of the digital lottery game may be set to be higher than a normal time. Further, one chip C1 may be exchanged with a predetermined number of medals, for example, 10 medals M. The player may collect the chip C, the possessed chip C is displayed on a possessed chip display portion 35. Two or more types of chips C may be provided. In this case, the number of possessed chips may be displayed on the possessed chip display portion 35 for each type of chip C.

When the number of orb balls B1 fallen onto the falling portion 24 reaches seven, each station unit ST executes the first roulette game as the digital lottery game. The center unit CN executes a jackpot game when a “jackpot chance” is won in the first roulette game executed by each station unit ST. Referring back to FIG. 1, the center unit CN will be described. The center unit CN is provided with a lottery mechanism 41 and a monitor 42. The lottery mechanism 41 is provided with a rotating plate 43 that rotates, a plurality of lottery holes 44 disposed in the rotating plate 43, and a lottery ball 45 that enters the lottery hole 44. The lottery mechanism 41 executes a second roulette game as a jackpot game. When the lottery ball 45 enters any one of the lottery holes 44, the medals M which are equal in number to the number associated with the corresponding lottery hole 44 are given to the player as payout, and supplied to the game field GF through the medal supply opening (not illustrated). When payout of the medal M is paid to the player who won the slot game or the first roulette game executed by each station unit ST, the medals M which correspond in number to the payout are supplied from the medal supply opening to the game field GF. When the jackpot game is executed, a predetermined rendering effect is displayed on the monitor 42. Even when the jackpot game is not displayed, a predetermined rendering effect may be displayed to boost a game.

FIG. 4 is a functional block diagram illustrating a configuration of a control system of the game machine 1. The station unit ST of the game machine 1 includes a station control unit 51 that executes various control processes to execute a predetermined game and a storage device 52. The game machine 1 is provided with a game machine control unit 71 that controls the game machine 1 entirely. The game machine control unit 71 controls the station control unit 51 of each station unit ST. The station control unit 51 and the game machine control unit 71 are configured as a computer unit in which a microprocessing unit (MPU) is combined with peripheral devices necessary to operate the MPU such as a random access memory (RAM) and a read only memory (ROM). The station control unit 51 is connected with the monitor 12, the touch panel 13, the medal dispensing opening 14, the medal inserting mechanism 53, a card identifying portion 54, and the medal detecting sensor 55, which are disposed in each station unit ST. The station control unit 51 transmits or receives a signal or data necessary for the progress of a game for each station unit ST. The card identifying unit 54 identifies a card by reading a player's ID (which may be hereinafter referred to as a “player ID”) recorded on a card inserted through a card insertion slot (not illustrated) disposed in the game machine 1. In addition, the station control unit 51 is connected to various sensors, mechanisms, and members necessary to execute or set a game, and controls transmission and reception of a signal or data or an operation. Examples of the storage device 52 include a magnetic storage medium, an optical storage medium, and a non-volatile storage medium such as an electrically erasable programmable read-only memory (EEPROM). The storage device 52 stores a game program 56 for executing a game through the game machine 1. In addition, the storage device 52 stores a variety of data necessary to execute a game.

As the station control unit 51 reads and executes the game program 56 stored in the storage device 52, a setting management portion 57, a digital medal control portion 58, and a game executing portion 59 are implemented inside the station control unit 51 as logical devices. The setting management portion 57 manages and controls setting of the digital medal DM, operation setting of a game, and a rendering-related process. The setting management portion 57 functions as a dispensing setting device that allows the player to set the medal dispensing opening 14 or the digital medal dispensing opening 34 as a dispensing destination of the medal M or the digital medal DM. The digital medal control portion 58 controls an operation of the digital medal DM displayed on the monitor 12. The game executing portion 59 executes various processes necessary for the progress of a game. The game executing portion 59 functions as a virtual game medium dispensing device by managing dispensing of the digital medal DM from the digital medal dispensing opening 34 displayed on the monitor 12.

The game machine 1 is connected to perform communication with a server 60 through a network. The server 60 is installed by an operator of the game machine 1, and provides various services using a network to the game machine 1 or the player of the game machine 1. The game machine 1 and the server 60 configure a game system 2. The server 60 is provided with a control unit 61 and a storage device 62. The control unit 61 is configured as a computer unit in which an MPU is combined with peripheral devices necessary to operate the MPU such as a RAM and a ROM. The control unit 61 executes updating of a game program or data. The control unit 61 performs authentication on the player of the game machine 1 using a player ID and a password, and then causes play history data 63, which includes the player's play history, save data, and the like, to be stored in the storage device 62 of the server 60. Examples of the storage device 62 include a magnetic storage medium, an optical storage medium, and a non-volatile storage medium such as an EEPROM. Each of the game machine 1 and the server 60 has a unique address identifying itself on a network, and a communication partner is specified using the address in communication between the game machine 1 and the server 60.

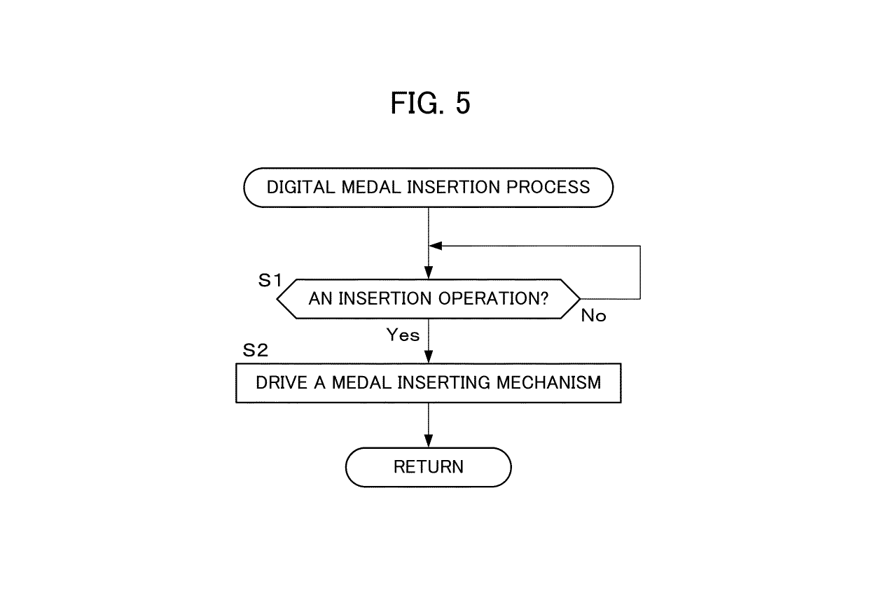

FIG. 5 is a flowchart illustrating a digital medal insertion process routine executed by the station control unit 51. The digital medal DM has a value equivalent to the medal M displayed on the monitor 12. The player can move the digital medal DM along the monitor 12 by a touch operation. The digital medal DM is obtained by inserting the medal M into a medal counter (not illustrated) disposed in the game machine 1. First, in step S1, the station control unit 51 determines whether or not an insertion operation of the digital medal DM has been performed. The insertion operation of the digital medal DM may be performed such that the player inserts the digital medal DM into the digital medal insertion slot 32. The digital medal DM inserted into the digital medal insertion slot 32 is displayed on the monitor 12 such that the digital medal DM moves toward the game field GF at a predetermined speed. When it is determined that the insertion operation of the digital medal DM has been performed, the process proceeds to step S2, and the station control unit 51 drives the medal inserting mechanism 53 and ends the current process. Based on the insertion operation of the digital medal DM performed through the operating unit 31, the medal inserting mechanism 53 inserts the medals M, which correspond in number to the insertion operation, into the game field GF. The medal M is inserted into the game field GF at natural timing when it is assumed that the medal M has moved up to the position at which the medal M is inserted into the game field GF at the speed of the digital medal DM moving through the medal insertion slot 32.

In the above process, each time the insertion operation of the digital medal DM is performed through the operating unit 31 (step S1), the medal inserting mechanism 53 is driven (step S2), so that the medal M is inserted into the game field GF. A smooth medal insertion operation can be performed such that the digital medal DM is displayed on the operating unit 31 and the medal M is inserted into the game field GF by the touch operation of the digital medal DM. The player can play a medal game without coming into direct contact with the medal M. The digital medal control portion 58 of the station control unit 51 functions as a control device by executing the processes of steps S1 and S2. Particularly, the digital medal control portion 58 functions as an insertion mechanism control device by executing the process of step S2.

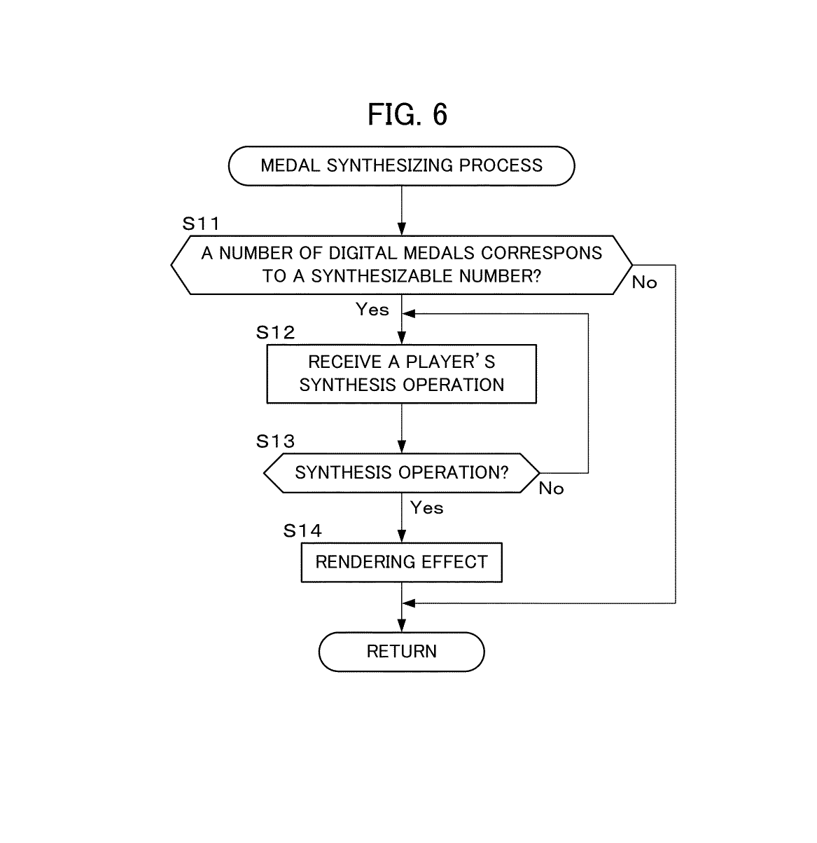

FIG. 6 is a flowchart illustrating a medal synthesizing process routine executed by the station control unit 51. Through the medal synthesizing process, a plurality of digital medals DM are synthesized into one digital medal DM, and the synthesized digital medal DM is subjected to the touch operation by the operating unit 31. In step S11, the station control unit 51 determines whether or not the number of digital medals DM corresponds to a synthesizable number. The number of digital medals DM which can be synthesized may be appropriately set and changed. For example, when the synthesizable number is set to 3, it is desirable to the player to possess three or more digital medals DM. The number of digital medals DM to synthesize may be designated by the player.

When it is determined that the number of digital medals DM corresponds to a synthesizable number, in step S12, the station control unit 51 receives the player's synthesis operation. The synthesis operation is received as necessary while a game is being played. A predetermined operation such as an operation of superimposing the digital medals DM by the player is set as the synthesis operation. When the player performs the synthesis operation, a window for confirming an intension about whether to synthesize the digital medals DM may be displayed. In step S13, the station control unit 51 determines whether or not the player has performed the synthesis operation. When the synthesis operation has been performed, the station control unit 51 executes a process of synthesizing the digital medals DM, and the process proceeds to step S14. In step S14, a predetermined rendering effect associated with the synthesis operation is made, and then the current process ends. In response to the synthesis operation performed by the player, the monitor 12 displays a rendering effect representing the synthesis of the digital medals DM and then displays a synthesized medal DMa. In FIG. 3, the synthesized medal DMa generated by synthesizing three digital medals DM is illustrated. The synthesized medal DMa is displayed to be distinguished from a normal digital medal DM. The number of synthesized medals is identifiably displayed on the synthesized medal DMa. When the synthesis operation has not been performed, the station control unit 51 causes the process to return to step S12, and receives the synthesis operation.

When the player performs the insertion operation of inserting the synthesized medal DMa into the digital medal insertion slot 32, the medals M which correspond in number to the synthesized number are inserted into the game field GF. The insertion operation of inserting the medal M into the game field GF is performed by the above-described digital medal insertion process. When the medal inserting mechanism 53 is driven in step S2, the medals M which correspond in number to the number of synthesized digital medals DM are continuously inserted into the game field GF. An insertion interval may be appropriately changed. The insertion interval may be set by the player.

In the above-described process, the synthesis operation of the digital medal DM is received (step S12) on the condition that the player possesses the digital medals DM which correspond in number to the synthesizable number (step S11). When the player has performed the synthesis operation (step S13), the rendering effect representing the synthesis of the digital medals DM is displayed on the monitor 12 (step S14). A plurality of digital medals DM is displayed as one synthesized medal DMa, the plurality of digital medals DM can be operated by operating the synthesized medal DMa, and a plurality of medals M can act on the game field GF. Particularly, when a plurality of medals M are inserted into the game field GF, the medals M can be continuously inserted into the game field GF by a simple operation using the synthesized medal DMa. Accordingly, operability related to insertion of the medal M into the game field GF is improved. The digital medal control unit 58 of the station control unit 51 functions as a virtual game medium synthesizing device by executing the processes of steps S11 to S14.

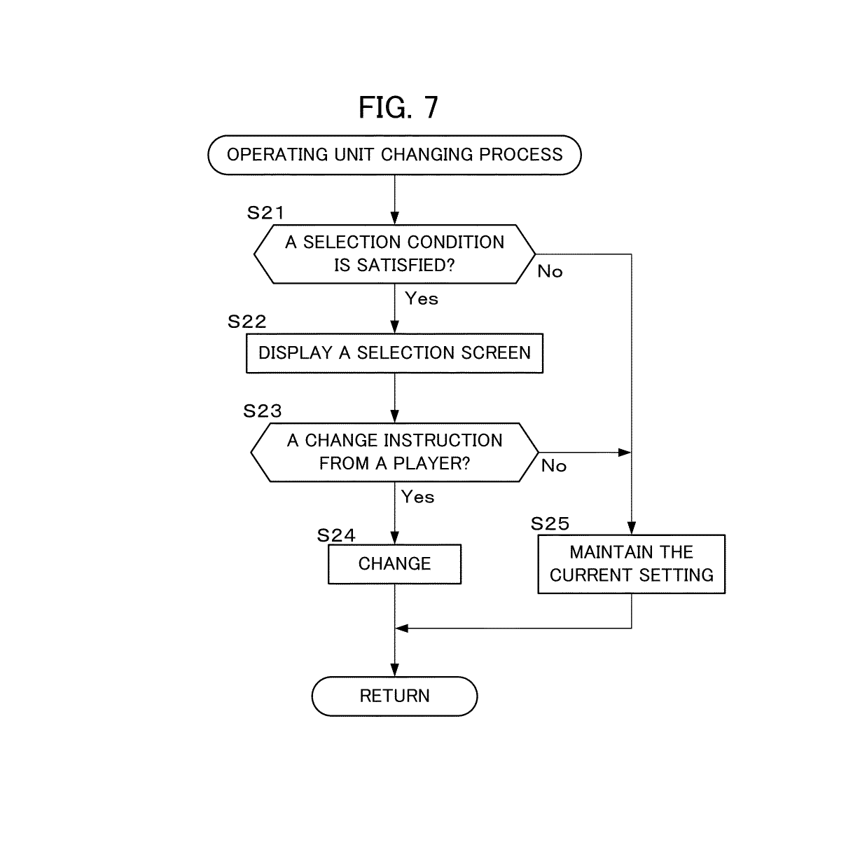

FIG. 7 is a flowchart illustrating an operating unit changing process routine executed by the station control unit 51. Through the operating unit changing process, the layout of the operating unit 31 for operating the digital medal DM is changed. In step S21, the station control unit 51 determines whether or not a selection condition for selecting an operation condition of the digital medal DM has been satisfied. For example, a predetermined item of the play history data 63 may be set as the selection condition. When the player's acquisition of an acquirable item in the lottery game played in the game machine 1 is set as the selection condition, it is determined whether or not the acquired item remains stored in the play history data 63. When the item remains stored, the selection condition is satisfied. When the selection condition is satisfied by each data of the play history data 63, a candidate of the operating unit 31 may be selected as the operation condition, or the operating unit 31 may be automatically set as the operation condition according to the satisfied selection condition. Further, it may be set as the selection condition to simply call a screen that allows the player to select the selectable layout of the operating unit 31. The selection condition may be appropriately set and changed, and it is possible to set various conditions in the progress of a game including selection by the player.

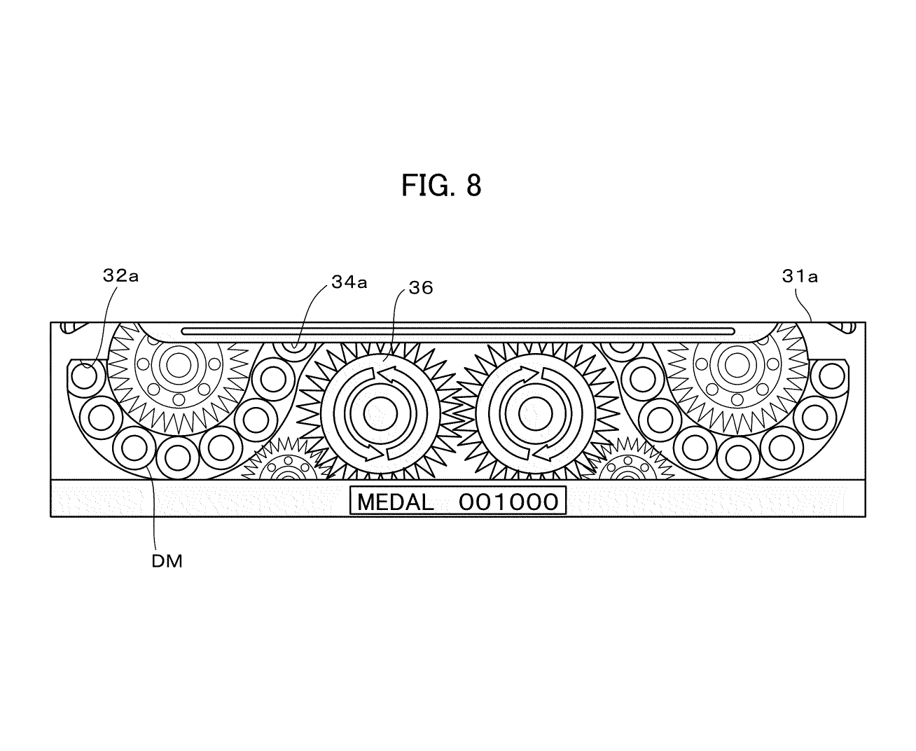

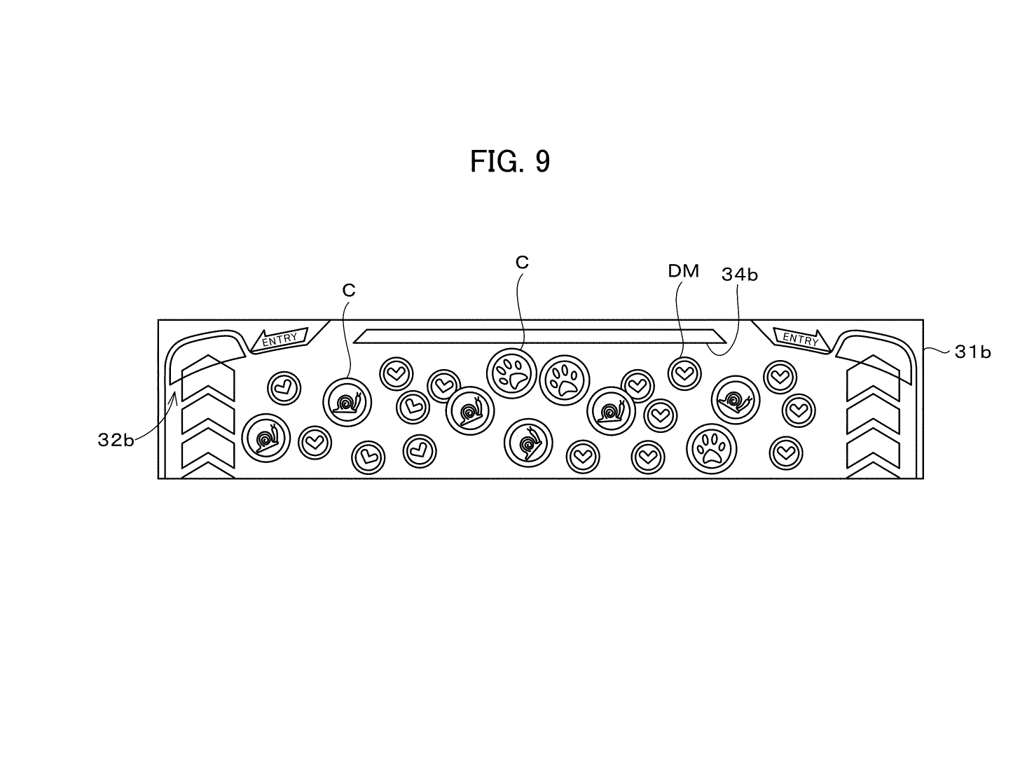

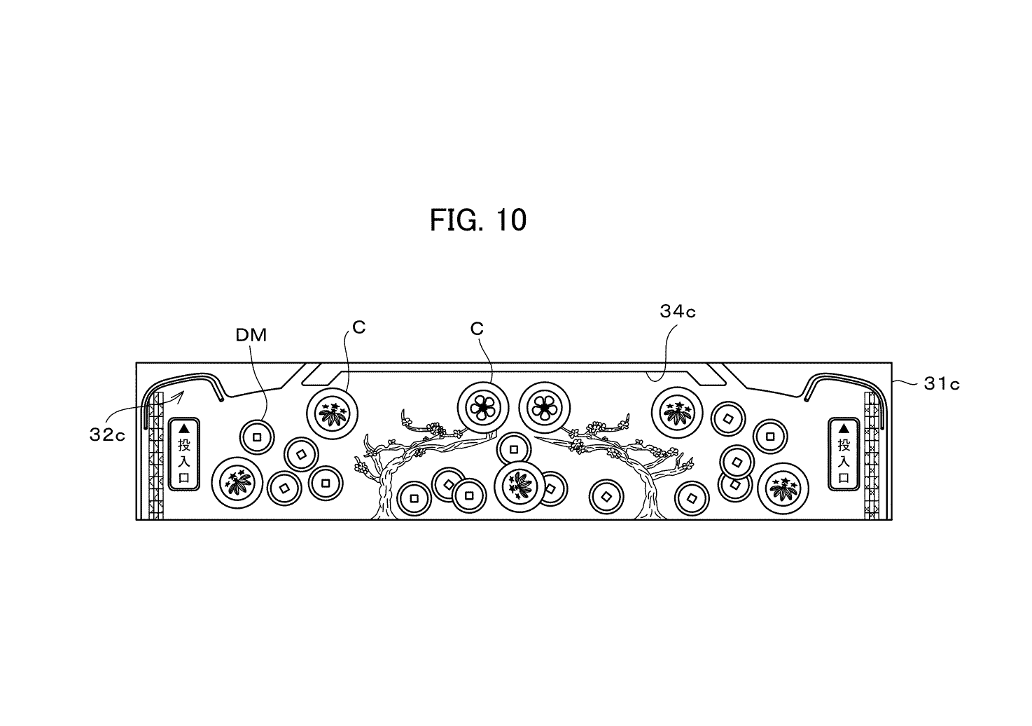

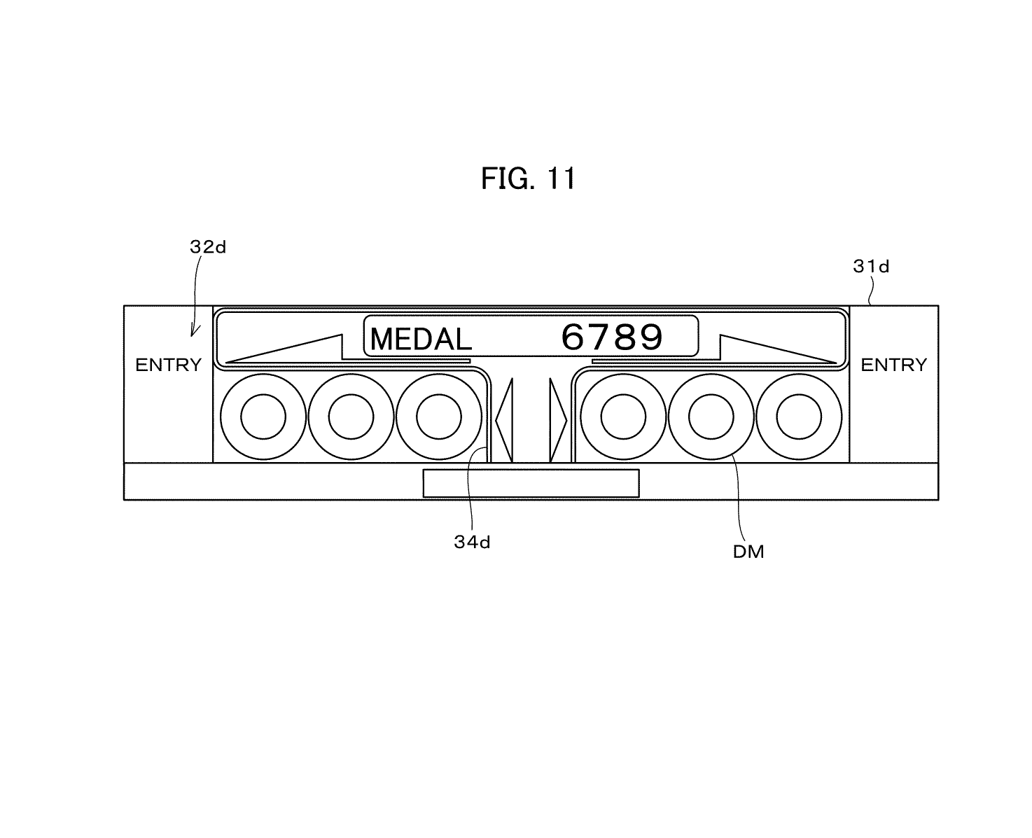

When the selection condition is satisfied, in step S22, the station control unit 51 displays a selection screen of the layout of the operating unit 31. FIG. 8 illustrates an example of the layout of the operating unit 31. FIGS. 9 to 11 illustrate other examples of the layout of the operating unit 31. Candidates 31a to 31d of the operating units illustrated in FIGS. 8 to 11 differ in the design of the digital medal DM or the chip C or differ in the layout of the digital medal insertion slots 32a to 32d or the digital medal dispensing openings 34a to 34d. The player may select his/her preferred design or the layout of the operating unit 31. The candidates 31a to 31d of the operating unit define the operation condition. As the operation condition, the shape of the digital medal insertion slot 32, the insertion operation method, the size of the digital medal DM, the speed at which the digital medal DM moves on the monitor 12, and the like are set for each of the candidates 31a to 31d of the operating unit. The candidate 31a of the operating unit is provided with an insertion operating portion 36 for performing the insertion operation of the digital medal DM. As a drag operation is performed along an arrow displayed on the insertion operating portion 36, the insertion operating portion 36 rotates, so that the digital medal DM is fed to the digital medal insertion slot 32. The insertion interval of the digital medal DM may change according to the rotation speed of the insertion operating portion 36. The candidates 31b and 31c of the operating unit are the same in the layout of the digital medal insertion slot 32 and the digital medal dispensing opening 34 but differ in the design thereof. The speed at which the digital medal DM moves on the monitor 12 may be set to differ according to each of the candidates 31b and 31c. In the candidate 31d of the operating unit, the digital medal DM of the large size is displayed, and as a slide operation in the left-right direction is performed on the digital medal DM, the digital medal DM is fed to the digital medal insertion slot 32d. The speed at which the digital medal DM moves the monitor 12 is also set to be slow. The operation condition has a concept including the design, the layout and the like of the operating unit 31 as well as an item related to the operation of the digital medal DM. The process proceeds to step S23, and the station control unit 51 determines whether or not there is a change instruction from the player.

When the player selects any one of the candidates of the operating unit 31, the process proceeds to step S24. In step S24, the station control unit 51 executes the process of changing the operating unit 31, and then ends the current process. For example, when the player selects the candidate 31a of the operating unit, the operating unit 31 displayed on the monitor 12 is changed to the candidate 31a of the operating unit selected by the player. Then, the player operates the insertion operating unit 36 disposed in the changed operating unit 31a to feed the digital medal DM to the digital medal insertion slot 32. Since the insertion operation method can be also changed according to the selected operating unit 31 in the above-described way, the player's preferred operating unit 31 can be used. The digital medal DM moves according to setting of each of the operating units 31a to 31d. When the player does not select the operating unit 31, in step S25, the station control unit 51 maintains the current setting of the operating unit 31 and then ends the current process. Further, even when it is determined in step S21 that the selection condition has not been satisfied, the process proceeds to step S25, and the station control unit 51 maintains the current setting of the operating unit 31 and then ends the current process.

In the above-described process, when a predetermined selection condition is satisfied (step S21), the screen to select the operating unit 31 is displayed on the monitor 12 (step S22). When the player gives the change instruction (step S23), the operating unit is changed to the operating unit 31 instructed by the player (step S24). A plurality of operating units 31 may be prepared in advance for an operation of the digital medal DM, and in this case, the player can use his/her preferred operating unit 31. The setting management portion 57 of the station control unit 51 functions as an operation condition selecting device by executing the processes of steps S21 to S25.

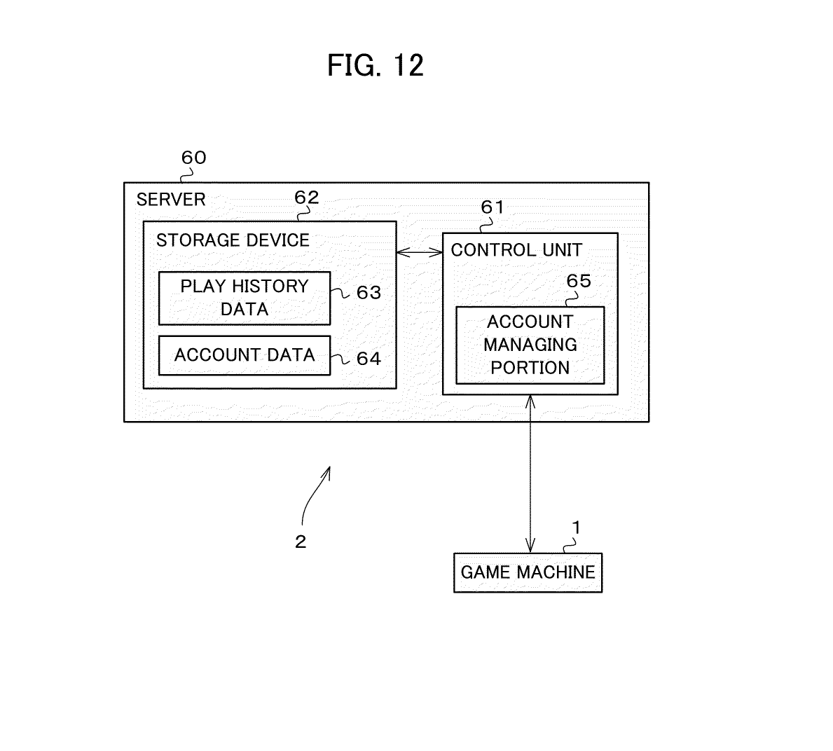

The invention is not limited to the above embodiments and may be embodied in various forms. For example, in this embodiment, the game machine 1 converts the medal M into the digital medal DM, but a method of obtaining the digital medal DM is not limited to this example. Further, for example, the digital medal DM may be purchased by withdrawing electronic cash from an account managed by the server 60. FIG. 12 is a functional block diagram illustrating a modified embodiment of the server 60. In this case, the storage unit 62 of the server 60 illustrated in FIG. 12 stores an account data 64 of the player, and an account managing portion 65 is implemented in the control unit 61 as a logical device according to a server program executed by the control unit 61. The game machine 1 has the same configuration as in FIG. 4, and the detail illustration will not be made. The account data 64 stores an amount of electronic cash held by the player in association with the player ID. The player can increase the amount of the electronic cash held in the account data 64 (by the deposit) through a web site or the like operated by a system operator or the like. Charging the player according to the deposit of the electronic cash is separately performed through a payment means such as a credit card, for example. Alternatively, the electronic cash may be deposited by exchanging cash using an electronic cash dedicated terminal or the like. The deposit of the electronic cash to the account data 64 and payment thereof may be performed in the same way as in a prepaid type electronic cash system, and a detailed description thereof will not be made.

The account managing portion 65 deals with a process related to management of an electronic cash account in which electronic cash of a designated amount is withdrawn from a corresponding record of the account data 64 in response to a fee withdrawal request from the game machine 1. For example, when a withdrawal process is requested together with a player ID and the amount of payment from the game machine 1, the account managing portion 65 specifies a record corresponding to the player ID with reference to the account data 64, and causes a fee by electronic cash to be paid by deducting the amount of payment from the amount held in the specified record. Thus, by electronic payment by the game machine 1, it is possible to purchase and use the digital medal DM. The account managing portion 65 functions as an electronic fee collecting unit. The game machine 1 may have a payment function. A fee may be paid such that payment is made between an IC tag of an IC card or the like capable of holding information related to electronic cash and a payment terminal functioning as an electronic fee collecting unit disposed in the game machine 1. The payment terminal and the IC card may be configured using a well-known technique.

Further, the game machine 1 may be interlocked with a medal depositing device via a network so that the medal M and the digital medal DM can be deposited by or dispensed to the game machine 1. The medal depositing device is a well-known device that is installed at a store in which the game machine 1 is installed and can deposit and dispense the medal M. The medal depositing device includes a card read portion that reads a card in which a player ID is recorded, and is connected to perform communication with the server 60 via a network. The server 60 manages the medal M deposited or dispensed by the medal depositing device in association with a player ID. The player causes the medal depositing device to be interlocked with the game machine 1 by causing the player ID to be authenticated in the medal depositing device and the game machine 1 using the player ID. Thus, the medal M or the digital medal DM can be deposited by or dispensed to the game machine 1. The player cause the digital medal DM to be dispensed at the time of game start, and causes the remaining digital medal DM after a game ends to be deposited. Thus, the player can enjoy a pusher game through the game machine 1 without coming into contact with the medal M from the beginning of a game to the end.

In the operating unit changing process, a plurality of candidates of the operating unit 31 have been described as the operation condition, but the operation condition is not limited to this example. For example, the size of the digital medal DM or the speed at which the digital medal DM moves on the monitor 12 may be separately set as the operation condition. The player may select a preferred size from among a plurality of candidates of the size of the digital medal DM, and the size of the digital medal DM may be set to be automatically changed based on the play history data 63. The moving speed of the digital medal DM may be set in the same way. As the operating unit 31 is displayed on the monitor 12, it is possible to prepare a wide variety of kinds of candidates of the operating unit 31 such as an operation method associated with insertion of the medal M, a design, a layout, and the like. Accordingly, the operating unit 31 can be customized according to the player's preference, thereby improving operability. Further, for example, a sound effect generated when the player comes into contact with the digital medal DM or a sound effect generated when the digital medal DM is inserted into the digital medal insertion slot 32 may be customized as the operation condition, according to the player's preference.

Further, in the operation changing process, when the selection condition is satisfied, in step S22 and subsequent steps, the process causing the player to instruct a change of the operating unit 31, but the invention is not limited to this example. For example, when the selection condition is satisfied, control may be performed such that an operation is automatically changed to an operation corresponding to the selection condition. For example, when a specific item is acquired in a lottery game, the operating unit 31 may be changed to be able to simultaneously deal with a number of digital medals DM. Accordingly, a game's property is diversified.

In the above embodiment, the operation of inserting the medal M into the game field GF is performed using the digital medal DM displayed on the operating unit 31, but the invention is not limited to this example. For example, the insertion operation of the ball B or movement of the ball B on the game field GF may be operated through the operating unit 31. An image of a ball may be displayed on the monitor 12, and the image of the ball may be configured to be operated in the same way as the digital medal DM. In addition, an operation of moving game media of various shapes such as a circular cylindrical shape or an ellipsoidal shape which moves on the game field GF may be performed through the operating unit 31. The invention is not limited to the insertion operation, and the medal M or the ball B on the game field GF may be moved by lifting up or down a table at a predetermined position on the game field GF. Even in this case, movement of the table may be operated through the operating unit 31.

What is claimed is:

1. A game machine comprising:
an input interface having a configuration in which a game field on which a game progresses according to movement of a physical game medium, a display device, and a touch panel superimposed on the display device are combined;
a control device which causes a virtual game medium associated with the physical game medium to be displayed on the display device, causes the virtual game medium to be associated with the player's touch operation, causes the virtual game medium to operate according to a predetermined operation condition, and applies an operation associated with an operation of the virtual game medium to a physical game medium; and
a operation condition selecting device which selects an operation condition in the control device according to a predetermined selection condition from among a plurality of candidates of the operation condition.

2. The game machine of claim 1, further comprising
an inserting mechanism which inserts the physical game medium into the game field, wherein
the control device includes an inserting mechanism control device which controls the inserting mechanism based on the touch operation made through the input interface.

3. The game machine of claim 2, wherein
the control device includes a virtual game medium synthesizing device which synthesizes a plurality of virtual game media into one synthesized virtual game medium on which a touch operation can be performed.

4. The game machine of claim 3, wherein
when a touch operation of inserting the physical game medium into the game field is performed on the synthesized virtual game medium, the inserting mechanism control device inserts physical game media which correspond in number to the number of virtual game media used for the synthesis of the synthesized virtual game medium into the game field.

5. The game machine of claim 1, wherein
the control device causes a predetermined number or less of virtual game media to be displayed on the display device, and when the number of virtual game media exceeds the predetermined number, the control device causes the exceeding number to be displayed.

6. The game machine of claim 2, further comprising:
a physical game medium insertion slot through which the physical game medium is inserted; and
a physical game medium detecting device which detects a physical game medium inserted into the physical game medium insertion slot, wherein
the inserting mechanism control device controls the inserting mechanism based on the detection result of the physical game medium detecting device.

7. The game machine of claim 1, further comprising:
a physical game medium dispensing device which dispenses the physical game medium to the player;
a virtual game medium dispensing device which dispenses the virtual game medium to the player; and
a dispensing setting device which sets either of the physical game medium dispensing device and the virtual game medium dispensing device as a dispensing device based on the player's selection.

8. The game machine of claim 1, wherein
a player's selection of the selection condition from a plurality of candidates of the operation condition is set, and the operation condition selecting device selects the operation condition based on the player's selection operation.

9. The game machine of claim 1, wherein
a predetermined item of a play history of a game play of a player is set as the selection condition, and the operation condition selecting device selects the operation condition based on the play history.

10. The game machine of claim 1, wherein
a touch operation to insert a physical game medium associated with a virtual game medium displayed on the display device into the game field is set as the operation condition.

11. The game machine of claim 1, wherein
the speed at which the virtual game medium displayed on the display device moves is set as the operation condition.

12. The game machine of claim 1, wherein
the size of the virtual game medium displayed on the display device is set as the operation condition.

13. The game machine of claim 1, comprising
an electronic fee collecting device which can collect a fee used to purchase a virtual game medium through an exchange of electronic payment information.

14. The game system comprising:
a game machine of claim 1; and
a server which can perform communication with the game machine via a network; wherein
the server includes an electronic fee collecting device which can collect a fee used to purchase a virtual game medium through an exchange of electronic payment information.
